(19) United States
(12) Patent Application Publication
(10) Pub. No.: US 2026/0086248 A1
(43) Pub. Date: Mar. 26, 2026

(54) Method for determining at least one protection radius associated with at least one navigation parameter, and associated electronic determination device

(71) Applicant: THALES, MEUDON (FR)

(72) Inventors: Nicolas Jean-Marc Frédéric VERCIER, VALENCE (FR); Vincent CHOPARD, VALENCE (FR); Muhammed HALEP, VALENCE (FR); Jacques COATANTIEC, VALENCE (FR)

(21) Appl. No.: 18/848,520

(22) PCT Filed: Mar. 15, 2023
(86) PCT No.: PCT/EP2023/056635

§ 371 Date: Nov. 6, 2025

(30) Foreign Application Priority Data
Mar. 23, 2022 (FR) FR2202568

(51) Int. Cl. G01S 19/39; G01C 21/16; G01S 19/49

(52) U.S. Cl. CPC G01S 19/396; G01C 21/165; G01S 19/49

(57) ABSTRACT

A method for determining at least one protection radius associated with at least one navigation parameter of a wearer. The method includes receiving a measurement from a sensor, an error bound, and an inertial measurement. The method further includes, for each successive reception instant, determining an estimated state vector on the basis of the measurement from the sensor and the inertial measurement. The method further includes computing an estimate error propagation matrix and a bounded error influence matrix, and computing transfer matrices on the basis of the calculated matrices. The method further includes determining navigation parameters from the estimated state vector and the associated protection radius on the basis of the calculated transfer matrices.

### CROSS-REFERENCE TO RELATED APPLICATIONS

This application claims benefit under 35 USC § 371 of PCT Application N. PCT/EP2023/056635 entitled METHOD FOR DETERMINING AT LEAST ONE PROTECTION RADIUS ASSOCIATED WITH AT LEAST ONE NAVIGATION PARAMETER, AND ASSOCIATED ELECTRONIC DETERMINATION DEVICE, filed on Mar. 15, 2023 by inventors Nicolas Jean-Marc Frédéric Vercier, Vincent Chopard, Muhammed Halep and Jacques Coatantiec. PCT Application No. PCT/EP2023/056635 claims priority of French Patent Application No. 22 02568, filed on Mar. 23, 2022.

### FIELD OF THE INVENTION

The present invention relates to a method for determining a protection radius associated with at least one navigation parameter of a carrier, such as the position, the speed, the attitudes and/or the heading of the carrier.

The present invention also relates to an electronic determination device configured to implement such a determination method.

A further subject matter of the present invention relates to a computer program product suitable for implementing such a determination method.

The invention relates to the field of integrated localization of a carrier, e.g. a mobile carrier. “Integrated location” means an estimate of navigation parameter(s), such as the position, speed, attitudes and/or heading of a carrier and the provision of a protection radius associated with the navigation parameter(s) considered. Thereby, it is guaranteed that an error in estimating the navigation parameter remains within the protection radius, according to a predefined probability.

### BACKGROUND OF THE INVENTION

It is known to estimate navigation parameters such as the position, speed, attitudes and heading of the carrier by performing hybridization from a GNSS (Global Navigation Satellite System) position estimated by a satellite positioning system and inertial measurements coming from an inertial measurement unit (IMU).

During the implementation of such an estimate, errors may disturb the estimation of the navigation parameters of the carrier. Such errors can be broken down into two types of errors: modeled errors, called rare and normal, and unmodeled but bounded errors.

The first type of error is usually modeled by a random variable that follows a continuous probability law. It is often assumed that the distribution of errors of the first type follows a normal distribution. By definition, the normal distribution is a probability distribution, often called a Gaussian distribution. In such case, it is clear that the values of the errors of the first type are not bounded. Nevertheless, since the distribution of the errors of the first type is known, it is possible to determine a bound which guarantees, for a predefined probability, that the errors of the first type stay included within said bound. Errors of the first type are subsequently called “rare and normal errors”. Physically, rare and normal errors most often result from intrinsic characteristics of the sensors used and which have an impact on the estimation of the navigation parameters of the carrier. Examples include thermal noise from the GNSS receiver or residual noise from inertial measurements.

For rare and normal errors, it is already known to determine a respective protection radius of at least one navigation parameter of the carrier, such as position, speed, attitudes and/or heading.

The second type of error concerns bounded but not modeled errors. Errors of the second type are comprised within an interval, formed by two bounds, but for which the distribution model is unknown. Hereinafter in the description, the errors of the second type are referred to as “bounded errors”. Physically, bounded errors correspond e.g. to errors related to the use of erroneous ephemerides for the computation of the GNSS position, or to a satellite clock failure in one of the satellites needed for the computation of the GNSS position.

It is not possible to know or predict the distribution or time evolution of errors of the second type. Only the interval of evolution of the error is known with a probability that guarantees that the error stays within the bounds of the interval with a confidence level characterized by said probability.

For example, the document U.S. Pat. No. 9,341,718B2 has attempted to provide a model of bounded errors. Similarly, in the article “Merging Kalman Filtering and Zonotopic—State Bounding for Robust Fault Detection under Noisy Environment” by C. Combastel, a mathematically more rigorous approach to modeling bounded errors was proposed.

However, in the aforementioned documents, the determination of the protection radius is not optimal.

### SUMMARY OF THE DESCRIPTION

Thereby, a subject matter of the invention is to improve the determination of the protection radius associated with a navigation parameter.

To this end, the invention relates to a determination method intended to give a bound to an error induced on at least one navigation parameter of a carrier, in particular a position, a speed, attitudes and/or a heading of the carrier, the error being induced by a measurement error the time evolution of which is unknown but one bound of which is known and the probability of not exceeding the bound is also known; the bound and the probability being known for a plurality of instants at which the method is implemented, the fact of bounding the induced error being obtained by the determination of at least one protection radius associated with the navigation parameters of the carrier, the method being implemented by an electronic determination device and comprising the following steps:
reception, at successive instants of reception, of a measurement coming from a sensor, such as a GNSS receiver, in particular a GNSS position, of at least one error bound associated with the measurement coming from the sensor, and inertial measurement(s):
for each successive instant of reception:
   determination of an estimated state vector of the carrier by application to the measurement coming from the sensor and to the inertial measurement of an estimation filter, the estimation filter comprising for each instant of reception, a gain, an observation matrix and a propagation matrix of the state vector;
   computation of a state estimation error propagation matrix on the basis of the state vector propagation matrix, of the estimation filter gain and of the observation matrix, and computation of an influence matrix of the bounded error on the basis of the state vector propagation matrix and of the gain;
   computation of N transfer matrices, on the basis of the N−1 transfer matrices computed at the instant preceding the instant of reception, of the estimation error propagation matrix at said instant of reception and of the influence matrix of the bounded error at said instant of reception, N being the number of successive instants of reception; and
   determination of the navigation parameter on the basis of the estimated state vector and determination of the protection radius associated with the navigation parameter, by summing unit contributions computed for at least part of the instants of reception, the unit contribution associated with each of said instants being computed from the transfer matrix computed for said instant and the error boundary received at that instant of reception.

The steps of calculating N transfer matrices and determining the protection radius from the N transfer matrices make it possible to easily and rapidly take into account the bounded errors in the determination of the protection radius. Thereby, the risk that the error on the navigation parameter of the carrier is greater than the protection radius is minimized without requiring a significant computation load.

More particularly, the method has the effect of limiting the induced error on navigation parameters of a carrier, such as the position, the speed, the attitudes and/or the heading of the carrier. The induced error is generated by a measurement error the time model of which is not known but the bound of which is known deterministically or with a given probability of not exceeding the bound.

According to other advantageous aspects of the invention, the determination method comprises one or a plurality of the following features, taken individually or according to all technically possible combinations:
for each instant of reception, the measurement coming from the sensor comprises M components, and the method further comprises, for each instant of reception, between the step of reception and the step of determination of an estimated state vector, an evaluation step including:
   for each component of the measurement coming from the sensor, computation of a unit gain of the filter; and
   evaluation of a gain from the M unit gains,
      during the step of determining the estimated state vector and the step of computation of the error propagation matrix and the influence matrix of the bounded error, the gain of the estimation filter being the estimated gain;
for each instant of reception, during the first computation step, the estimation error propagation matrix at said instant of reception is equal to:

$$F ( {T}_{N} ) ( I - {K}_{R} ( {T}_{N} ) H ( {T}_{N} ) ) ,$$

where:
F(T_{N}) is the propagation matrix of the state vector at said instant of reception;
I is the identity matrix;
Kᵣ(T_{N}) is the gain of the estimation filter at said instant of reception; and
H(T_{N}) is the observation matrix at said instant of reception,
   the influence matrix of the bounded error at said instant of reception being equal to:

$$F ( {T}_{N} ) {K}_{R} ( {T}_{N} )$$

the method further comprising, for each instant of reception, a step of writing each transfer matrix in a transfer shift register and each error bound received in a threshold shift register,
   during the computation step, the Nth transfer matrix being equal to the influence matrix of the bounded error at said instant of reception, and each of the other first transfer matrices being computed by multiplying the estimation error propagation matrix at said instant by each transfer matrix computed at the preceding instant of reception;
if during the reception step, at an instant of loss, the measurement coming from the sensor is not received, then the writing step of the instant of loss comprises:
   a freezing of the threshold shift register, and
   writing each transfer matrix in the transfer shift register without performing a shift in the transfer shift register;
for the instant of loss, during the first computation step, the estimation error propagation matrix at said instant of loss is equal to the propagation matrix of the state vector at said instant of loss and the influence matrix of the bounded error at said instant of adjustment is equal to the zero matrix;
for each instant of reception, during the step of determining the protection radius, each unit contribution is determined from at least one submatrix extracted from the transfer matrix computed at the instant of reception for the preceding one instant of reception, the computation of each unit contribution preferably including a computation of the eigenvalue(s) of one of the submatrices;
during the reception step, a contribution of rare and normal error(s) to the protection radius is received for at least one instant of reception; and the step of determining the protection radius comprising the computation of the sum of the rare and normal error contributions and the sum of the unit contributions.

A further subject matter of the invention relates to an electronic device for determining at least one protection radius associated with a navigation parameter of a carrier, the electronic device for determining comprising technical means suitable for implementing a determination method as described hereinabove.

A further subject matter of the invention is a computer program product comprising software instructions which, when executed by a computer, are apt to implement such a determination method.

### BRIEF DESCRIPTION OF THE DRAWINGS

The features and advantages of the invention will appear upon reading the following description, given as an example, but not limited to, and making reference to the enclosed drawings, wherein:

FIG. 1 is a schematic view of an electronic device according to the invention, on-board a carrier,

FIG. 2 is a flowchart of a determination method according to the invention, implemented by the determination device shown in FIG. 1; and

FIG. 3 is an explanatory diagram of a writing step of the method shown in FIG. 2, illustrated in an example.

### DETAILED DESCRIPTION OF EMBODIMENTS

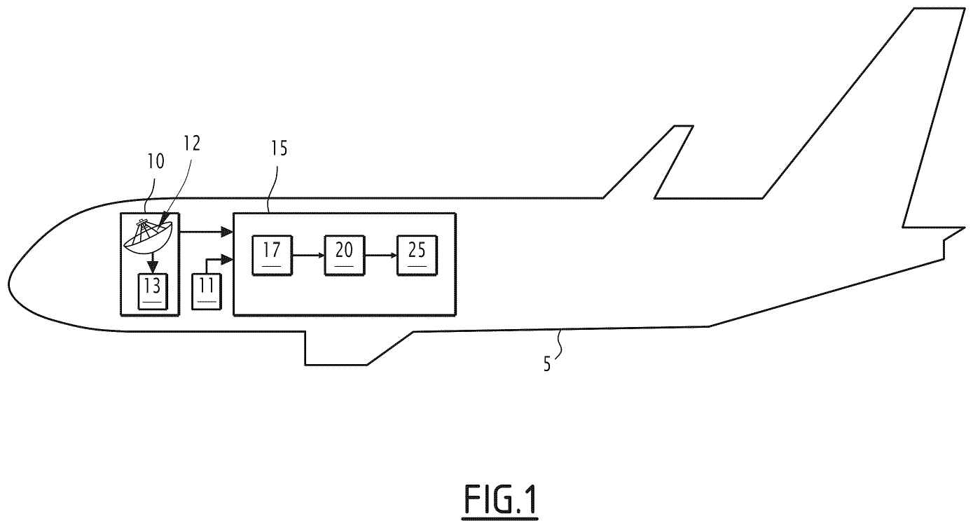

With reference to FIG. 1, a carrier 5 is mobile in an environment. The carrier 5 carries on-board, a sensor apt to of provide measurements, such as a GNSS receiver 10 apt to receive GNSS signals, an inertial positioning device 11 apt to provide inertial measurements and an electronic determination device 15 configured to determine at least one protection radius associated with at least one navigation parameter of the carrier 5.

GNSS is the abbreviation of Global Navigation Satellite System.

Alternatively, the receiver 10 is a barometric sensor, a Loch sensor, an odometer, a vision sensor, a LIDAR (Laser imagining Detection And Ranging) sensor, a SONAR (Sound Navigation And Ranging) sensor, a RADAR (Radio Detection and Ranging) sensor, a Doppler Velocity Log (DVL) sensor, or a Pitot tube.

The carrier 5 is e.g. an aircraft, such as a drone, an airplane or a helicopter, moving in space in three dimensions, or a land or sea vehicle moving in a plane in two dimensions or e.g. a railway vehicle moving along one direction along a railway track.

The GNSS receiver 10 is configured for receive GNSS signals from satellite(s) belonging to the same GNSS system, such as e.g. the GPS system. The GNSS receiver 10 comprises e.g. a reception antenna 12 known per se and a computation module 13.

The antenna 12 is configured for receiving GNSS signals from a plurality of satellites and transmitting them in the form of electrical signals to the computation module 13.

Without any loss of generality, hereinafter in the description, it will be considered that the measurement coming from the sensor is a GNSS position. It is clear that what will be described thereafter can also be generalized to other types of measurements coming from other sensors.

The computation module 13 is e.g. apt to determine a GNSS position of the receiver 10 from the GNSS signals received by the antenna 12, using techniques known per se. The GNSS position is e.g. in the form of a vector comprising three components: a GNSS longitude, a GNSS latitude and a GNSS altitude. The GNSS position includes both rare and normal errors and bounded errors.

Bounded errors fall within a finite range, but the probability that same take certain values within said range is indeterminable. More specifically, the bounded errors related to the horizontal position of the carrier 5 are comprised within the interval [−HIL; HIL], where HIL is a value of a horizontal error threshold which can change over time. Similarly, the bounded error related to the vertical position of the carrier 5 is comprised within the interval [−VIL; VIL], where VIL is a value of a vertical error threshold which can change over time.

Such thresholds are e.g. supplied directly at the output of the receiver 10 and are e.g. computed following the RAIM algorithm (Receiver Autonomous Integrity Monitoring) defined by the standard RTCA DO-229.

The computation module 13 is configured to form an error bound S on the basis of the horizontal HIL and vertical VIL threshold values. As an example, the error bound S comprises three components, the first two of which are equal to the horizontal error threshold HIL. The third component is then equal to the vertical error threshold value VIL.

The computation module 13 is also configured to send to the determination device 15, the computed GNSS position and the error bound S.

The inertial positioning device 11 comprises e.g. an inertial measurement unit (IMU) configured to measure linear accelerations and angular velocities of the carrier 5 in three mutually orthogonal directions. The inertial positioning device 11 is configured to determine, from these accelerations and these angular speeds, the inertial position of the carrier 5, according to a technique known per se, e.g. by applying a triple integration. In particular, such technique comprises e.g. a first integration of the attitude of the carrier 5 and then a projection of the orientation of different axes of the sensors and a double integration of the results. Such technique therefore serves to successively obtain information on the speed and on the position. Thereby, the inertial position has the form of a vector with three components: an inertial longitude, an inertial latitude and an inertial altitude.

The inertial positioning device 11 is further configured to transmit the determined inertial position to the determination device 15.

The determination device 15 comprises an input module 17, a processing module 20 and an output module 25.

According to a preferred embodiment, the input module 17, the processing module 20 and the output module 25 are each implemented in the form of software stored in one or a plurality of storage means (such as a hard disk or a flash disk) and implemented by one or a plurality of processors, memory (RAM) and other computer components known per se. Such components are then included in the same computer or in different computers/servers. In the latter case, the computers/servers are connected by a local or global network.

Furthermore or alternatively, at least a part of the modules 17, 20, and 25 takes the form, at least partially, of an independent electronic component, such as e.g. a programmable logic circuit such as a field-programmable gate array (FPGA) or other.

The input module 17 is configured to receive, at a plurality of instants of reception T_{N}, the GNSS position and the error bound S(T_{N}) from the GNSS receiver 10, and the inertial position from the inertial positioning device 11.

The input module 17 is configured to transmit to the processing module 20 the information received, namely: the GNSS position, the error bound S(T_{N}) and the inertial position received at the instant of reception T_{N}.

Hereinafter in the description, for any quantity “W”, the formulation “W(T_{N})” refers to the value of the quantity “W” at the instant of reception T_{N}. Moreover, the formulation “(Tᵢ)_{i=1, . . . , N}” refers to the set of instants of reception comprised between a first instant of reception “T₁” and a current instant of reception “T_{N}”. By analogy, the formulation “(W(Tᵢ))_{i=1, . . . , N}” refers to the set of values of the quantity “W” at each of the instants of receptions “(Tᵢ)_{i=1, . . . , N}”.

The processing module 20 is configured to process the information received for determining the protection radius RP(T_{N}) associated with a navigation parameter of the carrier 5. “Navigation parameter” refers to a parameter for locating the carrier 5, such as the horizontal position, the vertical position, the horizontal speed, the vertical speed, the horizontal acceleration or the vertical acceleration or else the roll, the pitch or the heading, the list being not exhaustive. To this end, the processing module 20 is configured for processing received information as described hereinafter in relation to the determination method according to the invention. The processing module 20 includes an estimation filter, comprising a gain K_{R}, an observation matrix H and a propagation matrix F of an estimated state vector X. The gain K_{R}, the observation matrix H, the propagation matrix F and the estimated state vector X are apt to evolve over time. For the above reason, same will subsequently be denoted by the references K_{R}(T_{N}), H(T_{N}), F(T_{N}) and X(T_{N}), respectively. The estimation filter is, e.g., a Kalman filter in one of the forms thereof such as e.g. an Extended Kalman Filter.

The processing module is in particular configured to merge data between the GNSS position and the inertial position, for each instant of reception T_{N}, on the basis of the estimation filter and according to a technique known per se. Such data fusion serves to estimate the estimated state vector X(T_{N}).

The observation matrix H(T_{N}) is the matrix determining the observable components of the estimated state vector X(T_{N}). “Observable components” refers to the measured components of the estimated state vector. In the example shown, the observable components correspond to the positions of the carrier 5.

The propagation matrix F(T_{N}) is the matrix linking the estimated state vector X(T_{N}) at the instant of reception T_{N} to the estimated state vector X(T_{N+1}) at the next instant of reception T_{N+1}.

The conventional formulation of the Kalman filter serves to adjust the estimate of a state vector at each instant of reception T_{N} by using a measurement vector z(T_{N}), e.g. equal to the difference between the GNSS position and the inertial position received at the instant of reception T_{N}.

It is known to adjust all the components of the estimated state vector X(T_{N}) simultaneously from the gain K_{R}(T_{N}) of the estimation filter, e.g. according to the equations:

$$X ( {T}_{N + 1} ) = X ( {T}_{N} ) + {K}_{R} ( {T}_{N} ) * ( z ( {T}_{N} ) - H ( {T}_{N} ) * X ( {T}_{N} ) ) \qquad [ MATH 1 ]$$

$$P ( {T}_{N + 1} ) = ( I - {K}_{R} ( {T}_{N} ) * H ( {T}_{N} ) ) * P ( {T}_{N} )$$

where P(T_{N}) is the covariance matrix associated with the estimation error of the estimated state vector X(T_{N}) at the instant of reception T_{N}.

A person skilled in the art knows that the covariance matrix is symmetrical positive definite.

The equations 1 are recursive, i.e. that the knowledge of the state variables X(T_{N}), of the gain K_{R}(T_{N}), of the measurement vector z(T_{N}), of the observation matrix H(T_{N}) and of the covariance matrix P(T_{N}) for the instant of reception T_{N} are necessary for the computation of the estimated state vector X(T_{N+1}) and of the covariance matrix P(T_{N+1}) for the next instant of reception T_{N+1}.

Moreover, the processing module preferentially includes in the memory thereof, a transfer matrix shift register and a threshold shift register, the utility of which will be discussed in detail hereinafter.

The output module 25 is connected to the processing module 20. The output module 25 is configured to transmit to a user or to another electronic device (not shown) the determined protection radius RP(T_{N}) and optionally the navigation parameter with which the protection radius RP(T_{N}) is associated.

If the output module 25 is configured for communicating with a user, the communication takes place e.g. by means of a screen (not shown).

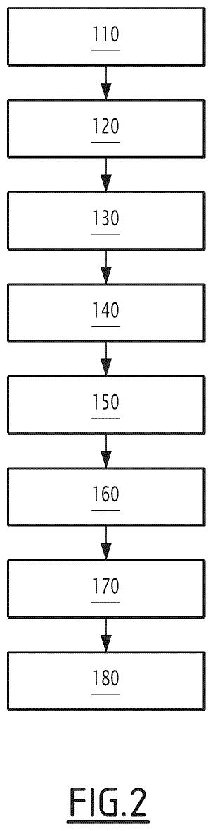

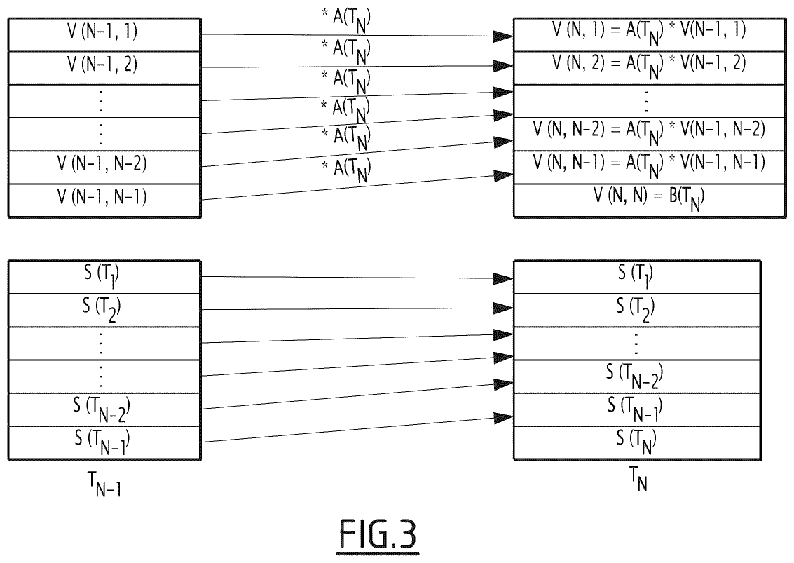

The determination method implemented by the electronic determination device 15 according to the invention will now be explained with reference to FIG. 2 which shows a flowchart of the method and to FIG. 3 illustrating a step of the method.

Initially, the carrier 5 moves in an environment and the GNSS receiver 10 receives, via the antenna 12 thereof, GNSS signals from a plurality of satellites. The computation module 13 computes the information mentioned hereinabove and sends the information to determination device 15. Similarly, the inertial positioning device 11 computes the inertial position and transmits same to the input module 17.

During a reception step 110, the input module 17 receives at a plurality of successive instants of reception (Tᵢ)_{i=1, . . . , N}, the GNSS position of the carrier 5, the inertial position of the carrier 5 and the error bound S(T_{N}). N is the number of instants of reception Tᵢ.

Then, for each successive instant of reception T_{N}, the method comprises the following steps.

During an optional evaluation step 120, the processing module 20 comprises the evaluation of a gain K_{R}(T_{N}) of the estimation filter. The evaluation step 120 is advantageously a computation of the gain K_{R}(T_{N}) of the estimation filter, on the basis of the unit gains (Kⱼ(T_{N}))_{j=1, . . . , M}.

The unit gains correspond to the gains used during successive component-by-component readjustments of the measurement vector received at the instant of reception T_{N}.

The processing module 20 determines the gain K_{R}(T_{N}) from the unit gains (Kⱼ(T_{N}))_{j=1, . . . , M}. To this end, the processing module applies e.g. the following equation, e.g., recursive on the number of measurements:

$${K}_{R , 1} ( {T}_{N} ) = {K}_{1} ( {T}_{N} ) \qquad [ MATH 2 ]$$

$$∀ j \geq 1 , {K}_{{R}_{j + 1}} ( {T}_{N} ) = [ \begin{matrix}( I - {K}_{j + 1} ( {T}_{N} ) * {H}_{j + 1} ( {T}_{N} ) ) * {K}_{{R}_{j}} & {K}_{j + 1} ( {T}_{N} )\end{matrix} ]$$

where:
I is the identity matrix,
* refers to the matrix product,
K_{R}(T_{N}) is the gain computed at the instant of reception T_{N} for a measurement vector z(T_{N}) comprising “M” component(s), et
Hⱼ₊₁(T_{N}) is the observation matrix associated with the unit gain Kⱼ₊₁(T_{N}) computed at the instant of reception T_{N} for the j+1-th component of the measurement vector z(T_{N}).

Equation 2 is based on the fact that the gain K_{R}(T_{N}) must has to satisfy the following equation:

$$( I - {K}_{m} ( {T}_{N} ) * {H}_{m} ( {T}_{N} ) ) * ... * ( I - {K}_{2} ( {T}_{N} ) * {H}_{2} ( {T}_{N} ) ) * ( I - {K}_{1} ( {T}_{N} ) * {H}_{1} ( {T}_{N} ) ) = ( I - [ \begin{matrix}{K}_{R , 1} ( {T}_{N} ) & {K}_{R , 2} ( {T}_{N} ) & … & {K}_{R , m} ( {T}_{N} )\end{matrix} ] * [ \begin{matrix}{H}_{1} ( {T}_{N} ) \\ {H}_{2} ( {T}_{N} ) \\ ⋮ \\ {H}_{m} ( {T}_{N} )\end{matrix} ] ) \qquad [ MATH 3 ]$$

where:
for all j, K_{R,j}(T_{N}) is the j-th column of the gain K_{R}(T_{N}), and
for any j, Hⱼ(T_{N}) is the j-th row of the observation matrix H(T_{N}).

In the example proposed wherein the GNSS and inertial positions are received during the reception step 110, the measurement vector z(T_{N}) comprises three components since the GNSS position and the inertial position comprise three components, respectively. Thereby, applying equation 2 to such case, gives a gain Kᵣ(T_{N}) equal to:

$${K}_{R} ( {T}_{N} ) = [ \begin{matrix}( I - {K}_{3} ( {T}_{N} ) {H}_{3} ( {T}_{N} ) ) * ( I - {K}_{2} ( {T}_{N} ) {H}_{2} ( {T}_{N} ) ) * {K}_{1} ( {T}_{N} ) & ( I - {K}_{3} ( {T}_{N} ) {H}_{3} ( {T}_{N} ) ) * {K}_{2} ( {T}_{N} ) & {K}_{3} ( {T}_{N} )\end{matrix} ] \qquad [ MATH 4 ]$$

Then, during a first determination step 130, according to a technique known per se, the estimated state vector (X(T_{N})) of the carrier 5 is determined from the gain K_{R}(T_{N}) evaluated during the evaluation step 120, the observation matrix H(T_{N}) and the propagation matrix F(T_{N}), e.g. according to equation 1 by initializing the estimated state vector X(T₁) to zero for the first instant of reception T₁.

Then, during a first computation step 140, the processing module 20 computes an estimation error propagation matrix A(T_{N}) of the state on the basis of the propagation matrix of the state vector F(T_{N}), of the gain K_{R}(T_{N}) of the estimation filter, and of the observation matrix H(T_{N}).

For example, the estimation error propagation matrix A(T_{N}) is computed according to the following equation:

$$A ( {T}_{N} ) = F ( {T}_{N} ) ( I - {K}_{R} ( {T}_{N} ) H ( {T}_{N} ) ) \qquad [ MATH 5 ]$$

The estimation error propagation matrix A(T_{N}) is computed on the basis of the gain K_{R}(T_{N}) of the estimation filter.

Still during the first computation step 130, the processing module 20 computes an influence matrix of the bounded error B(T_{N}), e.g. according to the following equation:

$$B ( {T}_{N} ) = F ( {T}_{N} ) {K}_{R} ( {T}_{N} ) \qquad [ MATH 6 ]$$

The estimation error propagation matrix A(T_{N}) and the influence matrix of the bounded error B(T_{N}) are derived from the following equation of evolution of the estimated state vector X(T_{N}):

$$X ( {T}_{N} ) = F ( {T}_{N} ) ( I - {K}_{R} ( {T}_{N} ) H ( {T}_{N} ) ) X ( {T}_{N - 1} ) + F ( {T}_{N} ) {K}_{R} ( {T}_{N} ) Seq ( {T}_{N} ) \qquad [ MATH 7 ]$$

where Seq(T_{N}) is a bounded error vector comprising the values of the bounded errors at the instant T_{N}.

It is clear that the bounded error vector Seq(T_{N}) is unknown since only the error limit S(T_{N}) is known. Thereby, each bounded error of the bounded error vector Seq(T_{N}) has an unknown value, comprised between the value HIL; VIL of the associated component in the error bound S(T_{N}) and the opposite of the value −HIL; −VIL of the associated component in the error bound S(T_{N}).

A person skilled in the art would observe that using equations 5 and 6, equation 7 is written in the form:

$$X ( {T}_{N} ) = A ( {T}_{N} ) X ( {T}_{N - 1} ) + B ( {T}_{N} ) Seq ( {T}_{N} ) \qquad [ MATH 8 ]$$

Then, during a second computation step 150, the processing module 20 computes N transfer matrices (V(N,i))_{i=1, . . . , N}. To this end, the processing module 20 computes the transfer matrices (V(N,i))_{i=1, . . . , N} from the N−1 transfer matrices (V(N−1, i))_{i=1, . . . , N-1} computed at the preceding instant of reception T_{N-1}, of the estimation error propagation matrix A(T_{N}) at said instant of reception T_{N} and of the influence matrix of the bounded error B(T_{N}) at said instant of reception T_{N}.

For example, the processing module 20 computes the transfer matrices (V(N,i))_{i=1, . . . , N} according to the following equation:

$$∀ i < N , V ( N , i ) = A ( {T}_{N} ) * V ( N - 1 , i ) \qquad [ MATH 9 ]$$

$$V ( N , N ) = B ( {T}_{N} )$$

It is clear that for the first instant of reception T₁, i.e. if N is equal to 1, the processing module 20 computes only the transfer matrix V(1,1) as being equal to the influence matrix of the bounded error B(T₁).

For example, at the second instant of reception T₂, the processing module computes the following transfer matrices V(2,2) and V(2, 1) according to the following equations:

$$V ( 2 , 2 ) = B ( {T}_{2} ) \qquad [ MATH 10 ]$$

$$V ( 2 , 1 ) = A ( {T}_{2} ) * V ( 1 , 1 ) = A ( {T}_{2} ) * B ( {T}_{1} )$$

Similarly, at the third instant of reception T₃, the processing module 20 computes the transfer matrices V(3,3), V(3,2), and V(3,1) according to the following equations:

$$V ( 3 , 3 ) = B ( {T}_{3} ) \qquad [ MATH 11 ]$$

$$V ( 3 , 2 ) = A ( {T}_{3} ) * V ( 2 , 2 ) = A ( {T}_{3} ) * B ( {T}_{2} )$$

$$V ( 3 , 1 ) = A ( {T}_{3} ) * V ( 2 , 1 ) = A ( {T}_{3} ) * A ( {T}_{2} ) * B ( {T}_{1} )$$

Then, during an optional writing step 160, the processing module writes each transfer matrix (V(N,i))_{i=1, . . . , N} in the transfer shift register and each error bound (S(Tᵢ))_{i=1, . . . , N} in the threshold shift register.

Thus, according to the optional supplement wherein the method comprises the writing step 160, the second computation step 150 and the writing step 160 are preferentially implemented simultaneously. Indeed, with reference to the left-hand part of FIG. 3, during the steps 150, 160, the transfer shift register is initially filled with the values of the computed transfer matrices (V(N−1,i)_{i=1, . . . , N-1} at the preceding instant of reception T_{N-1} and the threshold shift register is filled with the threshold vectors (S(Tᵢ))_{i=1, . . . , N-1} received between the first instant of reception T₁ and the preceding instant of reception T_{N-1}.

Then, the processing module 20 shifts each shift register to release a memory cell in each shift register.

Finally, and as can be seen in the right-hand part of FIG. 3, the processing module 20 multiplies each of the first N−1 values of the transfer shift register by the error propagation matrix A(T_{N}) computed at the instant of reception T_{N} and writes in the freed cell of the register, the influence matrix of the bounded error B(T_{N}) computed at said instant of reception T_{N}. According to equation 9, the transfer shift register then comprises the values of the transfer matrices (V(N,i))_{i=1, . . . , N} computed at the instant of reception T_{N} and for each instant of reception (Tᵢ)_{i=1, . . . , N} preceding or equal to said instant of reception T_{N}.

In parallel with the writing, the processing module 20 writes, in the freed cell in the threshold register, the error bound S(T_{N}) received at the instant of reception T_{N}.

In a variant, each shift register comprises a predetermined number of memory cells. The predetermined number of memory cells is also called the “depth of the shift register”. Thereby, when the processing module 20 performs the shift of each shift register, the transfer matrix V(N−1,L) computed at the preceding instant T_{N-1} and for the oldest instant T_{L} present in the transfer shift register, is expelled from the transfer shift register. Similarly, during such shift, the error bound S(T_{L}) received at the same oldest instant T_{L}, is expelled from the threshold shift register. The depth of the shift register is hence equal to N−L+1.

As an example, according to the preceding variant, the depth of each shift register is e.g. equal to 100, 50 or 10. If the depth is equal to 10, the transfer shift register comprises, for each instant of reception T_{N}, only the transfer matrices (V(N,i)_{i=N-9, . . . , N} computed between the instants of reception T_{N-9} and T_{N}. Similarly, the threshold shift register comprises the threshold vectors (S(Tᵢ))_{i=N-9, . . . , N} received between said same instants of receptions.

During a second determination step 170, the processing module 20 determines the navigation parameter of the carrier 5 from the estimated state vector X(T_{N}). For example, the navigation parameter is the horizontal position of the carrier 5, i.e. the longitude and latitude thereof. According to another example, the navigation parameter is the vertical position of the carrier 5, i.e. the altitude thereof.

The processing module 20 determines the navigation parameter as being equal to one or a plurality of the components of the estimated state vector X(T_{N}), or to a combination of one or a plurality of the components of the estimated state vector X(T_{N}), such as a linear combination.

During the second determination step 170 again, the processing module 20 determines the protection radius RP(T_{N}) associated with the determined navigation parameter, on the basis of the computed transfer matrices (V(N,i))_{i=1, . . . , N}.

To this end, if the navigation parameter is the horizontal position, the processing module 20 performs the following actions.

The processing module 20 extracts from each transfer matrix (V(N,i))_{i=1, . . . , N}, a horizontal-horizontal transfer submatrix V_{h,h}(N,i) comprising the coefficients of the transfer matrix V(N,i) the rows of which correspond to the rows of the components associated with the horizontal position in the estimated state vector X(T_{N}), and the columns of which correspond to the rows associated with the horizontal position in the error bound S(T_{N}). Each horizontal-horizontal transfer submatrix V_{h,h}(N,i) is thus a matrix of dimensions 2-2.

Similarly, the processing module extracts from each transfer matrix (V(N,i)_{i=1, . . . , N}, a horizontal-vertical transfer submatrix V_{h,v}(N,i) comprising the coefficients of the transfer matrix V(N,i) the rows of which correspond to the rows of the components associated with the horizontal position in the estimated state vector X(T_{N}), and the column of which corresponds to the row associated with the vertical position in the error bound S(T_{N}). Each horizontal-vertical transfer submatrix V_{h,v}(N,i) is thus a matrix of dimensions 2-1.

Then, the processing module 20 computes a unit contribution PL(Tᵢ) for at least part of the instants of reception (Tᵢ)_{i=j, . . . , N}, e.g. for each instant of reception (Tᵢ)_{i=1, . . . , N} or for the instants of reception (Tᵢ)_{i=L, . . . , N} for which a transfer matrix V(N,i) is present in the transfer shift register. The index variable j is either equal to 1 if the depth of the shift register is greater than the number of values stored in said register, or to L if the shift register is already complete and the depth of the register is equal to N−L+1.

The processing module 20 computes e.g. each unit contribution PL(Tᵢ) from the following equation:

$$PL ( {T}_{i} ) = HIL ( {T}_{i} ) * \sqrt{max ( eig ( {{V}_{h , h} ( N , i )}^{T} * {V}_{h , h} ( N , i ) ) )} + VIL ( {T}_{i} ) * \sqrt{( {{V}_{h , v} ( N , i )}^{T} * {V}_{h , v} ( N , i ) )} \qquad [ MATH 12 ]$$

where:
\sqrt{-} is the square root function,
eig(-) is the function for calculating the eigenvalue(s),
max(-) is the maximum function, and
-^{T} is the matrix transpose.

In a variant, if the navigation parameter is the vertical position, the processing module 20 performs the following actions.

The processing module 20 extracts from each transfer matrix (V(N,i))_{i=j, . . . , N}, a vertical-horizontal transfer submatrix V_{v,h}(N,i) comprising the coefficients of the transfer matrix V(N,i) the row of which corresponds to the row of the component associated with the vertical position in the estimated state vector X(T_{N}), and the columns of which correspond to the rows associated with the horizontal position in the error bound S(T_{N}). Each vertical-horizontal transfer submatrix V_{v,h}(N,i) is thus a matrix of dimensions 1-2.

Similarly, the processing module extracts from each transfer matrix (V(N,i))_{i=j, . . . , N}, a vertical-vertical transfer submatrix V_{v,v}(N,i) comprising the coefficient of the transfer matrix V(N,i), the row of which corresponds to the row of the component associated with the vertical position in the state vector X(T_{N}), and the column of which corresponds to the row associated with the vertical position in the error bound S(T_{N}). Each vertical-vertical transfer submatrix V_{v,v}(N,i) is thus a matrix of dimension 1-1. In other words, each vertical-vertical transfer matrix V_{v,v}(N,i) is a scalar number.

Then, the processing module 20 computes a unit contribution PL(Tᵢ) for at least part of the instants of reception (Tᵢ)_{i=j, . . . , N}, e.g. for each instant of reception (Tᵢ)_{i=1, . . . , N} or for the instants of reception (Tᵢ)_{i=L, . . . , N} for which a transfer matrix V(N,i) is present in the transfer shift register.

For example, the processing module computes each unit contribution PL(Tᵢ) from the following equation:

$$PL ( {T}_{i} ) = HIL ( {T}_{i} ) * \sqrt{{V}_{v , h} ( N , i ) * {{V}_{v , h} ( N , i )}^{T}} + VIL ( {T}_{i} ) * \vert {V}_{v , v} ( N , i ) \vert \qquad [ MATH 13 ]$$

where |-| is the absolute value function.

Then, still during the second determination step 170, the processing module 20 determines the protection radius RP(T_{N}) from each unit contribution (PL(Tᵢ))_{j=1, . . . , N} computed, independently of the way in which the unit contributions have been computed.

For this purpose, the processing module 20 determines the protection radius RP(T_{N}), e.g. according to the following equation:

$$RP ( {T}_{N} ) = {\sum }_{i = j}^{N} PL ( {T}_{i} ) \qquad [ MATH 14 ]$$

where:
j is the first index for which a unit contribution PL(Tᵢ) is computed,

$${\sum }_{i = j}^{N}$$

- is the sum on the index i changing between j and N, and

Then, during a transmission step 180, the output module 25 transmits to the user or to the other electronic device (not shown) the determined protection radius RP(T_{N}) and, optionally, the navigation parameter with which the protection radius is associated.

According to a first variant of embodiment, during the reception step 110, the input module 17 also receives the contribution to the protection radius PL_{FF}(T_{N}) coming from rare and normal errors.

According to the first variant of embodiment, during the second determination step 170, the protection radius RP(T_{N}) is then computed, e.g. by the following equation:

$$RP ( {T}_{N} ) = {PL}_{FF} ( {T}_{N} ) + {\sum }_{i = j}^{N} PL ( {T}_{i} ) \qquad [ MATH 15 ]$$

A second variant of embodiment, e.g. which can be combined with the first variant of embodiment, is now presented. Such variant can be used e.g. for each instant of loss T_{P} for which the GNSS position and/or the error bound S(T_{P}) is lost or invalidated. For such instants, the method does not comprise the evaluation step 120. According to the second variant, during the first determination step 130, the estimated state vector X(T_{P}) is determined only by prediction, i.e. without adjustment. The above means setting the gain K_{R}(T_{N}) to zero for such instants.

According to the second variant still, during the computation step 140, the estimation error propagation matrix A(T_{N}) and the influence matrix of the bounded error B(T_{N}) are computed, e.g. according to the following equation:

$$A ( {T}_{N} ) = F ( {T}_{N} ) \qquad [ MATH 16 ]$$

$$B ( {T}_{N} ) = 0$$

Then, during the computation step 150, each transfer matrix (V(P,i))_{i=j, . . . , P-1} is computed, e.g. according to the following equation:

$$∀ i \leq P - 1 , V ( P , i ) = A ( {T}_{P} ) V ( P - 1 , i ) \qquad [ MATH 17 ]$$

It is clear that during the second computation step 150, at most P−1 transfer matrices V(P,i) are computed.

Then, during the writing step 160, the processing module 20 freezes the threshold shift register. In other words, the processing module does not shift the threshold shift register. During the writing step 160, the processing module 20 writes each transfer matrix (V(P,i))_{i=j, . . . P-1} computed in the transfer shift register without performing any prior shift of the register.

With the method according to the invention, the determination of the protection radius RP(T_{N}) is improved. With the protection radius RP(T_{N}) determined by the method according to the invention, the probability that the error on the navigation parameter is greater than the protection radius RP(T_{N}) is e.g. less than 10⁻⁷/h.

With the method according to the invention, the computation of the protection radius RP(T_{N}) is easy and rapid to implement. It is thereby possible to implement the method according to the invention on the electronic determination device 10 on-board the carrier 5.

The optional evaluation step 120 allows a real-time readjustment by using the gain K_{R}(T_{N}) of the estimation filter by limiting the risk that numerical approximations affect the characteristic(s) of the matrices of the estimation filter.

With the method according to the first variant pf embodiment, the determination of the protection radius RP(T_{N}) is further improved since same takes into account both the bounded errors and the rare and normal errors.

With the method according to the third variant of embodiment, the determination method is more robust since same allows the protection radius to continue to be determined even when the GNSS position is lost.

1. A method comprising:
receiving, at successive instants of reception, a measurement coming from a sensor, of at least one error bound associated with the measurement coming from the sensor and inertial measurement(s):
for each successive instant of reception:
determining an estimated state vector of a carrier by application to the measurement coming from the sensor and to the inertial measurement of an estimation filter, the estimation filter comprising for each instant of reception, a gain, an observation matrix and a propagation matrix of the state vector;
computing an estimation error propagation matrix of the state on the basis of the propagation matrix of the state vector, of the gain of the estimation filter and of the observation matrix;
computing an influence matrix of the bounded error on the basis of the propagation matrix of the state vector and of the gain;
computing N transfer matrices, on the basis of the N−1 transfer matrices computed at the instant preceding the instant of reception, from the estimation error propagation matrix at the instant of reception and from the influence matrix of the bounded error at the instant of reception, N being the number of successive instants of reception;
determining a navigation parameter from the estimated state vector;
determining a protection radius associated with the navigation parameter, comprising summing unit contributions computed for at least part of the instants of reception, the unit contribution associated with each of the instants of reception being computed on the basis of the transfer matrix computed for the instant and of the error bound received at the instant of reception.

2. The method according to claim 1, wherein for each instant of reception, the measurement coming from the sensor comprises M components, and wherein the method further comprises, for each instant of reception, between said receiving and said determining an estimated state vector:
for each component of the measurement coming from the sensor, computing a unit gain of the filter; and
evaluation of a gain from the M unit gains, during said determining the estimated state vector, said computing the error propagation matrix and of matrix, and said computing the influence matrix of the bounded error, the gain of the estimation filter being the evaluated gain.

3. The method according to claim 2, wherein for each time of reception, in said computing an estimation error propagation matrix, the estimation error propagation matrix at the time of reception is equal to:
$$F ( {T}_{N} ) ( I - {K}_{R} ( {T}_{N} ) H ( {T}_{N} ) ) ,$$
where:
F(T_{N}) is the propagation matrix of the state vector at the instant of reception,
I is the identity matrix,
K_{R}(T_{N}) is the gain of the estimation filter at the instant of reception, and
H(T_{N}) is the observation matrix at the instant of reception, the influence matrix of the bounded error at the instant of reception being equal to:
$$F ( {T}_{N} ) {K}_{R} ( {T}_{N} ) .$$

4. The method according to claim 1, further comprising, for each time of reception:
writing each transfer matrix in a transfer shift register; and
writing each received error bound in a threshold shift register,
during said computing N transfer matrices, the Nth transfer matrix is equal to the influence matrix of the bounded error at the instant of reception, and each of the other first transfer matrices are computed by multiplying the estimation error propagation matrix at the instant by each transfer matrix computed at the preceding instant of reception.

5. The method according to claim 4, wherein if, during said receiving, at an instant of loss, the measurement coming from the sensor is not received, then said writing comprises:
freezing the threshold shift register; and
writing each transfer matrix (V(P,i)_{j=1, . . . , P-1)} in the transfer shift register without performing a shift in the transfer shift register.

6. The method according to claim 5, in which, for the instant of loss, during said computing an estimation error propagation matrix, the estimation error propagation matrix at said instant of loss is equal to the propagation matrix of the state vector at the instant of loss and the influence matrix of the bounded error at the instant of loss is equal to the zero matrix.

7. The method according to 1, wherein for each time of reception, during said determining the protection radius, each unit contribution is determined from at least one submatrix extracted from the transfer matrix computed at the time of reception for a preceding instant of reception.

8. The method according to claim 1, wherein during said receiving, a contribution of rare and normal error(s) to the protection radius is received for at least one instant of reception, said determining the protection radius comprising:
computing the sum between the contribution of rare and normal error(s); and
computing the sum of the unit contributions.

9. An electronic device for determining at least one protection radius associated with a navigation parameter of a carrier, the electronic determination device comprising apparatus suitable for implementing a method according to claim 1.

10. A computer program comprising software instructions which, when executed by a computer, cause the computer to implement a method according to claim 1.

11. The method according to claim 7, wherein the computation of each unit contribution comprises computing the eigenvalue(s) of one of the submatrices.
